(19) United States
(12) Patent Application Publication
(10) Pub. No.: US 2026/0271139 A1
(43) Pub. Date: Sep. 10, 2026

(54) ELECTRODE AND SPACER ELEMENT

(71) Applicant: TENNECO GMBH, Edenkoben (DE)

(72) Inventors: Krzysztof STAWINOGA, Edenkoben (DE); Joachim GEHRLEIN, Rheinzabern (DE); Tomasz CHELSTOWSKI, Edenkoben (DE); Peter RÄSCH, Edenkoben (DE); Florian KUNATH, Wiesbaden (DE)

(21) Appl. No.: 19/106,051

(22) PCT Filed: Aug. 24, 2023
(86) PCT No.: PCT/EP2023/073245

§ 371 Date: Feb. 24, 2025

(30) Foreign Application Priority Data
Aug. 25, 2022 (DE) 10 2022 121 591.1

(51) Int. Cl. H05B 3/06

(52) U.S. Cl. CPC H05B 3/06

(57) ABSTRACT

A heating resistor is provided for insertion into an exhaust pipe, wherein the heating resistor is formed into a shape comprising a plurality of heating loops arranged next to one another, which form a basic shape, wherein the respective heating loop is formed from two bars, wherein adjacent bars of the heating loops are separated by a groove having a groove axis, wherein at least one bar comprises a receiving opening comprising a cross-sectional shape for receiving an insulator, wherein the adjacent bar in the region of the receiving opening
a) is flat, or
b) comprises a contact surface comprising a cross-sectional shape.

### CROSS-REFERENCE TO RELATED APPLICATIONS

This application is a U.S. National Phase Application under 35 U.S.C. 371 of International Application No. PCT/EP2023/073245, filed on Aug. 24, 2023, which claims priority to German Patent Application No. 10 2022 121 591.1, filed on Aug. 25, 2022. The entire disclosure of the above German application is incorporated herein by reference.

### FIELD

The disclosure relates to a heating resistor for insertion into an exhaust pipe for heating exhaust gas, wherein the heating resistor comprises a basic shape_G, in which one or more heating loops arranged next to one another are provided, which form the basic shape_G, wherein the respective heating loop is formed from two bars coupled at their ends, a bar_1 and a bar_2, wherein adjacent bars of the heating loop or adjacent bars of the heating loops are separated by a groove having a groove axis or by a gap.

### BACKGROUND

This section provides background information related to the present disclosure which is not necessarily prior art.

A heating resistor having a spacer element is already known from U.S. Pat. No. 5,501,842 A. The heating resistor comprises transverse grooves into which insulator elements are inserted.

The disclosure is directed at designing and arranging a heating resistor in such a way that the continuous load capacity is increased.

### SUMMARY

This section provides a general summary of the disclosure, and is not a comprehensive disclosure of its full scope or all of its features.

The problem is solved in accordance with the disclosure in that at least one bar_1 comprises a receiving opening comprising a cross-sectional shape_A for receiving an insulator, wherein the adjacent bar_2 in the region of the opening
a) is flat, or
b) comprises a contact surface comprising a cross-sectional shape_F, which is not equal to the cross-sectional shape_A. The cross-sectional shape_A or the cross-sectional shape_F may be round, oval, polygonal or angular.

The different design of the contact surface on the adjacent bar_2 in the area of the receiving opening prevents a positive locking between the insulator and the bar_2, so that the insulator may be moved in both directions with respect to the bar_2 and with respect to the groove axis. This enables a low-load relative movement between the insulator and the bar_2 when heating up the heating resistor. A relative movement between the bar_1 and the insulator is not provided. The same is achieved if a receiving opening comprising a cross-sectional shape_F is provided as the contact surface, wherein the cross-sectional shape_F deviates from the cross-sectional shape_A or is larger than the cross-sectional shape_A to such an extent that a load-free relative movement between the bar_2 and the insulator in the direction of the groove axis is possible when insulators are used. In the direction of the main exhaust gas flow, i.e. normal to the surface of the heating resistor, the respective insulator may be inserted into the receiving opening. With reference to the three translational spatial axes, there is at least one bivalent bearing between the insulator and the bar_1. However, the insulator may at least be brought into contact with the bar_2 in a direction transverse to the groove axis or transverse to the exhaust gas flow.

It may also be advantageous if the receiving opening comprises two flanks that ensure a positive locking in the direction of the groove axis with an insulator to be inserted into the receiving opening. The insulator may be placed against the bar_1 with a positive locking in relation to a spatial axis running parallel to the groove axis. This means that a positive locking may be created between the insulator and the bar_1 in both directions of the groove axis.

Furthermore, a heating element may be advantageous, comprising a heating resistor as described above and insulators mounted therein.

It may also be advantageous if the insulator comprises a cross-sectional shape_L, wherein only the bar_1 comprises a receiving opening comprising a cross-sectional shape_A that corresponds to a portion of the cross-sectional shape_L, wherein the respective insulator is in a positive locking with the receiving opening in both directions in relation to the groove axis. This means that the connection of the insulator to the bar_1 is sufficiently firm.

It may be advantageous if the adjacent bar_2 comprises a contact surface comprising a cross-sectional shape_F in the area of the receiving opening, wherein the insulator comprises a contact zone comprising a cross-sectional shape_Z, wherein the cross-sectional shape_Z is not equal to the cross sectional shape_F. A deviating cross-sectional shape_F ensures a load-free relative movement between the bar_2 and the insulator.

For this purpose, it may be advantageous if the cross-sectional shape_F comprises a radius_R and the cross-sectional shape_Z comprises a radius r, wherein R>r, or R>=2r. This ensures sufficient freedom of movement of the insulator relative to the bar_1 in relation to the groove axis.

It may also be advantageous if a gap is provided between the contact zone of the insulator and the adjacent bar_2. This allows for reducing the groove width or gap width when heating the heating resistor until the insulator contacts the bar_2. Thus, the pressure acting on the insulator or the bar may be reduced in a direction transverse to the groove axis.

It may be advantageous if the receiving opening comprises an undercut, wherein there is a positive locking between the insulator and the bar_1 in a direction Q transverse to the groove axis. There may be a fairly large gap between the insulator and the adjacent bar_2 (in the cold state). This gap may be reduced or enlarged during heating of the heating element. Regardless of the size of the gap, however, the insulator remains in bar_1. The insulator is therefore always prevented from slipping out of the receiving opening in the direction Q transverse to the groove axis. The insulator resting against the bar_2 is mounted having a positive locking in relation to two spatial axes. The free third spatial axis is used to insert the insulator into the receiving opening.

It may also be advantageous if the receiving opening comprises a round, oval, polygonal or angular cross-sectional shape_A and/or if at least the portion of the insulator to be received through the receiving opening comprises a round, oval, polygonal or angular cross-sectional shape_A. This also prevents the insulator from rotating within the receiving opening.

The insulator is made of a ceramic material or is designed as a metal pin having a ceramic coating.

In addition, a system consisting of a heating element as described above and at least a part of an exhaust system in the form of an exhaust pipe, wherein the heating resistor is arranged inside the exhaust pipe, may be advantageous.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further advantages and details of the disclosure are explained in the claims and in the description and shown in the figures.

It shows:

FIG. 1 perspective view of a heating element;

FIG. 2a-3c detail sketches.

### DETAILED DESCRIPTION

Example embodiments will now be described more fully with reference to the accompanying drawings.

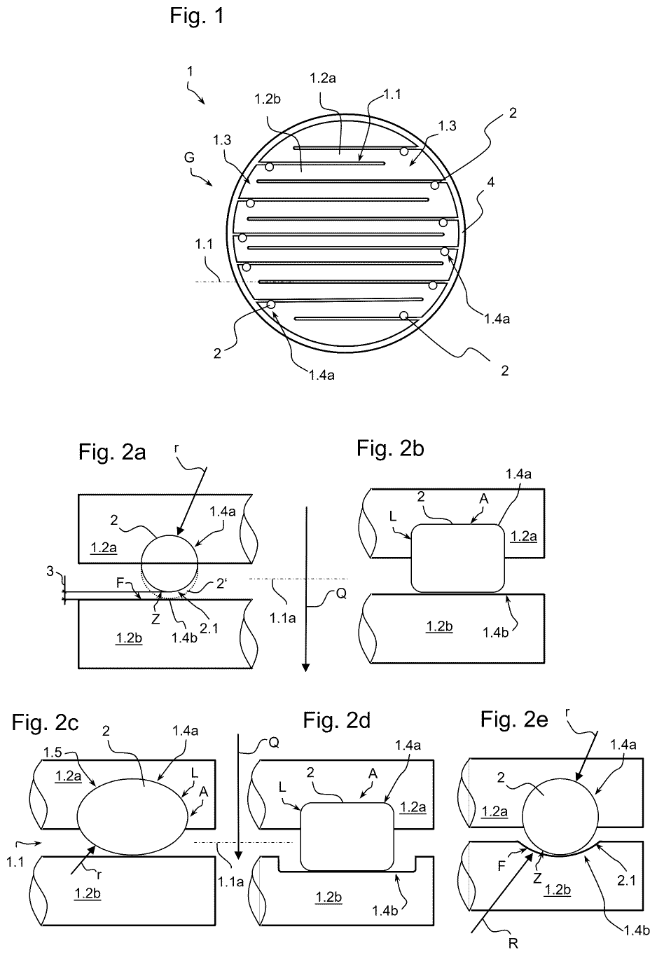

A heating element 10 shown in FIG. 1 comprises a heating element in the form of a heating resistor 1. The heating resistor 1 comprises several heating loops 1.3, which are formed from two bars 1.2a, 1.2b or bar_1 and bar_2 (hereinafter referred to as 1.2a and 1.2b), which are connected at their ends. Adjacent bars 1.2a, 1.2b are separated from each other by a groove 1.1 having a groove axis 1.1a. An insulator 2 is provided in the end region of the groove 1.1, respectively, which ensures a distance between adjacent heating loops 1.2a, 1.2b. The heating resistor 1 comprises a round basic shape_G, which ensures that it can be mounted in an equally round exhaust pipe 4.

The detailed illustrations in FIGS. 2a to 3c show the end region of a groove 1.1 between two adjacent bars 1.2a, 1.2b. The two bars 1.2a, 1.2b are separated from each other by the groove 1.1. An insulator 2 is provided in the area of the respective groove end, which is accommodated in the bar 1.2a. For this purpose, the bar 1.2a comprises a receiving opening 1.4a comprising a cross-sectional shape_A that extends transversely to the groove axis 1.1a. The insulator 2 is supported in the receiving opening 1.4a. The cross-sectional shape_L of the portion of the insulator 2 embedded in the receiving opening 1.4a corresponds to the cross-sectional shape_A. The insulator 2 is positioned at a level of a contact surface 1.4b of the adjacent bar_1.

According to the embodiments 2a to 2d, the contact surface 1.4b of the bar 1.2b or its cross-sectional shape_F is flat in the area of the insulator 2 or in the area or at the level of the adjacent receiving opening 1.4a. The same applies to the embodiment of FIG. 2b. Here, the contact surface 1.4b is also flat, wherein the size of the contact surface is limited to the expansion of the required groove within the bar 1.2b.

According to the embodiments of FIG. 2a to 2e, there is virtually no gap 3 (in the cold state) or a very small gap 3 between the insulator 2 and the adjacent bar 1.2b. This gap 3 may be changed when the heating element is heated. However, the insulator 2 is not provided with a fixed seat within the receiving opening 1.4a; the insulator 2 can be moved in a direction Q transverse to the groove axis 1.1. The cross-sectional shape_L of the insulator 2 embedded in the receiving opening 1.4a corresponds to the cross-sectional shape_A. Against the background of a maximum achievable gap width, it is possible for the insulator 2 to slip out of the receiving opening 1.4a in the direction Q transverse to the groove axis 1.1. However, as shown in FIG. 2a, the insulator 2′ rests against the adjacent bar 1.2b or the contact surface 1.4b. This means that the insulator 2 always remains at least partially in the receiving opening 1.4a.

According to the embodiments of FIGS. 3a to 3c, the insulator 2 is received in the bar 1.2a via a positive locking with respect to a direction Q transverse to the groove axis 1.1. For this purpose, the bar 1.2a or the receiving opening 1.4a comprises an undercut 1.5. Thus, a positive locking between the insulator 2 and the bar 1.2a is ensured in both directions with respect to the groove axis 1.1a. There is a fairly large gap 3 between the insulator 2 and the adjacent bar 1.2b (in the cold state). This gap 3 may be reduced or enlarged when the heating element is heated. Regardless of the size of the gap 3, however, the insulator 2 remains within the bar 1.2a. The insulator 2 is therefore always prevented from slipping out of the receiving opening 1.4a in the direction Q transverse to the groove axis 1.1.

According to the embodiments of FIGS. 2a, 2e, 3a, the embedded portion of the insulator 2 comprises a circular cross-sectional shape_L, with the receiving opening 1.4a comprising a correspondingly semi-circular cross-sectional shape_A. According to FIG. 3a, the receiving opening 1.4a comprises a depth t that is greater than a radius r of the round insulator 2, so that said undercut is ensured.

According to the embodiment of FIG. 2c, the embedded portion of the insulator 2 comprises an oval cross-sectional shape_L. The receiving opening 1.4a correspondingly comprises a partially oval cross-sectional shape_A, so that the insulator 2 can be inserted into the receiving opening 1.4a in a direction normal to the image plane. Here, an undercut of the receiving opening 1.4a is provided. This is not necessary, because the insulator 2 rests against the bar 1.2b or its contact surface 1.4b.

According to the embodiment of FIG. 3b, the insulator 2 comprises an overall trapezoidal cross-sectional shape_L, while, according to FIG. 3c, the insulator 2 comprises a frustoconical cross-sectional shape_L comprising a round contact zone 2.1 or cross-sectional shape_Z. According to the embodiments of FIGS. 2b, 2d, 3b, the contact zone 2.1 is flat.

According to the two embodiments of FIGS. 2e, 3c, the contact surface 1.4b or its cross-sectional shape_F is round. The radius R of the contact surface 1.4b is approximately twice as large as the radius r of the contact zone 2.1 of the insulator 2 or the radius r of the cross-sectional shape_Z. This results in only a minimal form fit between the contact zone 2.1 of the insulator 2 and the opposite bar 1.2b in a direction parallel to the groove axis 1.1.

FIG. 3a′ shows the embodiment of FIG. 3a, but without an insulator. Here, the two flanks 1.41, 1.42 of the receiving opening 1.4a can be seen.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or de-scribed. The same may also be varied in many ways. Such variations are to be re-garded as a departure from the disclosure, and all such modifications are intended to be included within the scope of the disclosure.

1. A heating element for insertion into an exhaust pipe, the heating resistor comprising a basic shape in which one or more heating loops arranged next to one another are formed, wherein the respective heating loop is formed from two bars coupled at their ends, a bar and a bar, adjacent bars delimiting a groove having a groove axis
wherein
at least one bar comprises a receiving opening having a cross-sectional shape for receiving an insulator, wherein the adjacent bar in the region of the receiving opening
a) is flat; or
b) comprises a contact surface having a cross-sectional shape which is not equal to the cross-sectional shape.

2. The heating element according to claim 1,
wherein
the receiving opening comprises two flanks ensuring a positive locking, acting into the direction of the groove axis, with an insulator to be inserted into the receiving opening.

3. The heating element comprising a heating resistor according to claim 1 and insulators mounted therein.

4. The heating element according to claim 3, wherein
the insulator comprises a cross-sectional shape, wherein only one bar comprises a receiving opening comprising a cross-sectional shape which corresponds to a portion of the cross-sectional shape,
wherein the respective insulator can be brought into a positive locking with the receiving opening in both directions with respect to the groove axis.

5. The heating element according to claim 4, wherein
the adjacent bar in the region of the receiving opening comprises a contact surface comprising a cross-sectional shape, wherein the insulator comprises a contact zone comprising a cross-sectional shape, the cross-sectional shape being unequal to the cross-sectional shape.

6. The heating element according to claim 5, wherein
the cross-sectional shape comprises a radius and the cross-sectional shape comprises a radius r, wherein R>r or R>=2r.

7. The heating element according to claim 3,
wherein
a gap is provided between the contact zone of the insulator and the adjacent bar.

8. The heating element according to claim 3,
wherein
the receiving opening comprises an undercut, there being a positive locking between the insulator and the bar in a direction Q transverse to the groove axis.

9. The heating element according to claim 3,
wherein
the receiving opening comprises a round, oval, polygonal or angular cross-sectional shape and/or at least the portion of the insulator to be received by the receiving opening comprises a round, oval, polygonal or angular cross-sectional shape.

10. A system comprising a heating element according to claim 4 and at least a part of an exhaust system in the form of an exhaust pipe, wherein the heating resistor is arranged inside the exhaust pipe.
